(19) United States
(12) Patent Application Publication
(10) Pub. No.: US 2026/0276784 A1
(43) Pub. Date: Sep. 17, 2026

(54) RADAR DEVICE

(71) Applicant: DENSO CORPORATION, Kariya-city (JP)

(72) Inventors: Katsuhiko KONDO, Nisshin-city (JP); Yusuke AKAMINE, Nisshin-city (JP); Takuya TAKAYAMA, Kariya-city (JP)

(21) Appl. No.: 19/674,560

(22) Filed: May 12, 2026

Related U.S. Application Data
(63) Continuation of application No. PCT/JP2024/041294, filed on Nov. 21, 2024.

(30) Foreign Application Priority Data
Nov. 24, 2023 (JP) 2023-199074

(51) Int. Cl. G01S 7/40; G01S 13/62; G01S 13/72; G01S 13/931

(52) U.S. Cl. CPC G01S 7/403; G01S 13/62; G01S 13/72; G01S 13/931

(57) ABSTRACT

A radar device for a mobile object includes a detection unit, a speed acquisition unit, a tracking unit, a stationary object determination unit, a distance acquisition unit, an expected angle calculation unit, and an error calculation unit. The tracking unit acquires a time series of object information corresponding to at least one object determined to be the same as a first object. When the first object is a stationary object, the distance acquisition unit acquires, from the acquired time series of object information, a first distance acquired when the vehicle passed directly beside the first object. The expected angle calculation unit calculates an expected angle based on the acquired first distance and a second distance detected at a current time. The error calculation unit calculates, as an azimuth error at a first azimuth angle detected at the current time, a difference between the calculated expected angle and the first azimuth angle.

### CROSS-REFERENCE TO RELATED APPLICATION

This application is a continuation application of International Application No. PCT/JP2024/041294 filed Nov. 21, 2024 which designated the U.S. and claims priority to Japanese Patent Application No. 2023-199074 filed with the Japan Patent Office on Nov. 24, 2023, the contents of each of which are incorporated herein by reference.

### BACKGROUND

### Technical Field

The present disclosure relates to a technique for measuring an azimuth angle of an object.

### Related Art

A known object detection device derives a first distance and a first azimuth angle of a first target and a second distance to a second target, based on reflected waves of a transmission wave transmitted from a radar device mounted to a vehicle. The first target and the second target are aligned along the travel direction of the vehicle, and the second target is located directly beside the vehicle. Further, the object detection device derives, based on the first distance and the second distance, a second azimuth angle that is an expected azimuth angle of the first target, and calculates a difference between the first azimuth angle and the second azimuth angle. The object detection device corrects the azimuth angle derived based on the reflected waves by using the difference.

### BRIEF DESCRIPTION OF THE DRAWINGS

In the accompanying drawings:

FIG. 1 is a block diagram illustrating a configuration of a radar device according to a first embodiment;

FIG. 2 is an illustration of a detection field of each radar device according to the first embodiment;

FIG. 3 is a block diagram illustrating functions of a signal processing unit according to the first embodiment;

FIG. 4 is a flowchart illustrating an azimuth error calculation process performed by the signal processing unit in the first embodiment;

FIG. 5 is a flowchart illustrating a stationary object extraction process performed by the signal processing unit according to the first embodiment;

FIG. 6 is a flowchart illustrating a directly lateral position acquisition process according to the first embodiment;

FIG. 7 is an illustration of a situation in which roadside objects are located non-parallel to a road;

FIG. 8 is an illustration of a time series of positions of roadside objects detected by the radar device according to the first embodiment;

FIG. 9A is an illustration of a method for calculating an expected angle according to the first embodiment;

FIG. 9B is an illustration of a method for calculating an expected angle according to a comparative example;

FIG. 10 is an illustration of horizontal azimuths before correction, azimuth errors, and horizontal azimuths after correction according to the first embodiment;

FIG. 11 is an illustration of estimated values of azimuth error and measured true values of azimuth error according to the first embodiment;

FIG. 12 is a flowchart illustrating a directly lateral position acquisition process performed by a signal processing unit according to the second embodiment;

FIG. 13 is a flowchart illustrating a directly lateral position acquisition process performed by a signal processing unit according to a third embodiment; and

FIG. 14 is a flowchart illustrating an azimuth error calculation process performed by a signal processing unit according to a fourth embodiment.

### DESCRIPTION OF SPECIFIC EMBODIMENTS

Roadside objects present in an actual travel environment are not necessarily aligned along the travel direction of the vehicle. As a result of detailed studies conducted by the inventors, it was found that the above known object detection device, as disclosed in JP 6,933,986, assumes that the first target and the second target are aligned along the travel direction of the vehicle. Accordingly, when the object detection device is used in an actual travel environment, an error may occur in estimating the difference between the first azimuth angle and the second azimuth angle.

In view of the foregoing, it is desired to have a radar device capable of calculating an azimuth error with high accuracy.

One aspect of the present disclosure provides a radar device for use in a mobile object, including a detection unit, a speed acquisition unit, a tracking unit, a stationary object determination unit, a distance acquisition unit, an expected angle calculation unit, and an error calculation unit. The detection unit is configured to detect, at predefined time intervals, object information on an object present in a detection region around the mobile object based on transmitted and received radar waves, the object information including a distance, a relative speed, and an azimuth angle of the object. The speed acquisition unit is configured to acquire a speed of the mobile object. The tracking unit is configured to (i) determine whether a first object corresponding to the object information detected by the detection unit at a current time is the same as any object corresponding to object information detected by the detection unit at a previous time, and (ii) acquire a time series of object information, the time series of object information including the object information detected by the detection unit at the current time and object information detected by the detection unit at previous times and corresponding to at least one object determined to be the same as the first object. The stationary object determination unit is configured to determine whether the first object is a stationary object based on the relative speed and the azimuth angle included in the object information detected by the detection unit and the speed of the mobile object acquired by the speed acquisition unit. The distance acquisition unit is configured to acquire, when the stationary object determination unit determines that the first object is a stationary object, a first distance corresponding to the distance included in the object information acquired when the mobile object passes directly beside the first object among the time series of object information acquired by the tracking unit. The expected angle calculation unit is configured to calculate an expected angle based on the first distance acquired by the distance acquisition unit and a second distance included in the object information detected by the detection unit at the current time. The error calculation unit is configured to calculate an azimuth error for each azimuth angle, the error calculation unit being configured to calculate, as the azimuth error at a first azimuth angle included in the object information detected by the detection unit at the current time, a difference between the expected angle calculated by the expected angle calculation unit and the first azimuth angle.

A radar device according to one aspect of the present disclosure acquires a time series of object information of the same stationary object. A detected position of the same stationary object changes over time according to behavior of the vehicle. Accordingly, based on the behavior of the vehicle, a temporal change in the detected position of the same stationary object is estimated, and a first distance is acquired in consideration of the temporal change in the position. Then, an expected angle is calculated based on the first distance and the second distance. This allows the radar device to calculate the expected angle while suppressing an error caused by arrangement or shape of the object, which allows the radar device to calculate the azimuth error with high accuracy.

Embodiments of the present disclosure will be now described with reference to the accompanying drawings.

### First Embodiment

### 1-1. Configuration

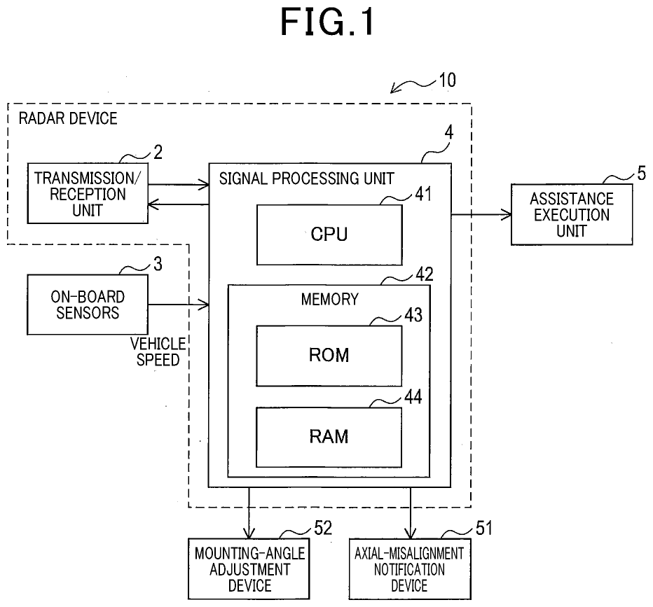

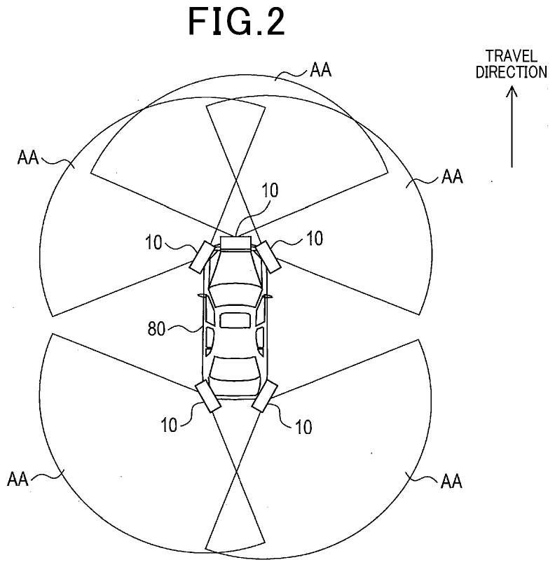

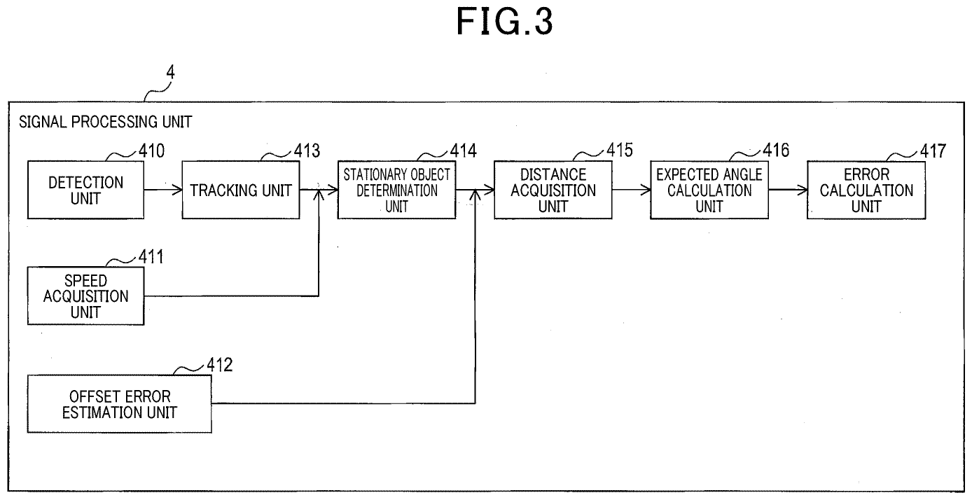

A configuration of a radar device 10 according to the present embodiment will be described with reference to FIGS. 1 to 3. In the present embodiment, the radar device 10 is mounted to a vehicle 80. Specifically, the radar devices 10 are mounted at a front center of the vehicle 80, for example, at a center inside a front bumper. The radar devices 10 are also mounted at left and right front sides of the vehicle 80, for example, at left and right ends inside the front bumper, and at left and right rear sides of the vehicle 80, for example, at left and right ends inside a rear bumper. The radar devices 10 mounted at the above-described five locations define detection fields Rd at the front center, left front, right front, left rear, and right rear of the vehicle 80, respectively. It is not necessary that all of these five radar devices 10 be mounted to the vehicle 80. Only one of the five radar devices 10 may be mounted to the vehicle 80, or two or more of the radar devices 10 may be mounted to the vehicle 80. Alternatively, six or more radar devices 10 may be mounted to the vehicle 80. In another embodiment, the radar device 10 may be mounted to a mobile object other than the vehicle 80, such as an aircraft, a ship, or a train.

The radar device 10 includes a transmission/reception unit 2 and a signal processing unit 4. The transmission/reception unit 2 includes a transmission antenna and a reception antenna. The transmission antenna repeatedly transmits radar waves in a predefined cycle set by the signal processing unit 4. The reception antenna receives a reflected wave generated by reflection of the transmitted radar wave from an object, and sends a reception signal based on the received reflected wave to the signal processing unit 4.

The signal processing unit 4 includes a CPU 41 and a memory 42. The memory 42 includes a ROM 43 and a RAM 44. The signal processing unit 4 causes the CPU 41 to execute various programs, thereby implementing various functions and executing a process of detecting object information about an object around the vehicle 80 based on the reception signal. The object information includes a distance from the vehicle 80 to the object, a relative speed of the object relative to the vehicle 80, and an azimuth angle of the object relative to the vehicle 80.

The signal processing unit 4 also causes the CPU 41 to execute various programs, thereby implementing various functions and executing a process of calculating an azimuth error Δθ. Further, the signal processing unit 4 estimates an offset error of the azimuth angle. Specifically, the signal processing unit 4 has functions of a detection unit 410, a speed acquisition unit 411, an offset error estimation unit 412, a tracking unit 413, a stationary object determination unit 414, a distance acquisition unit 415, an expected angle calculation unit 416, and an error calculation unit 417.

The azimuth error Δθ is caused by a decrease in measurement accuracy of the azimuth angle due to a distance from the radar device 10 mounted inside the bumper to the bumper and/or a shape of the bumper. The azimuth error Δθ depends on the azimuth angle, and the value of azimuth error differs according to the azimuth angle.

The offset error is an azimuth angle error caused by misalignment of an axis of the radar device 10. The offset error does not depend on the azimuth angle and has the same value in all directions. The offset error changes due to, for example, an impact received by the vehicle 80 while the vehicle 80 is traveling and/or stopped.

The signal processing unit 4 is also connected to on-board sensors 3, an assistance execution unit 5, an axial misalignment notification device 51, and a mounting angle adjustment device 52. The on-board sensors 3 are various sensors mounted to the vehicle 80, and output measured values to the signal processing unit 4. The various sensors include a vehicle speed sensor that measures a vehicle speed, a yaw rate sensor that measures a yaw rate, a steering angle sensor that measures a steering angle, and the like.

The assistance execution unit 5 assists traveling of the vehicle 80 based on a position of the object detected by the signal processing unit 4. For example, when a possibility that the vehicle 80 will collide with the object becomes high, the assistance execution unit 5 outputs a warning and/or controls traveling of the vehicle 80 to avoid the collision.

The axial misalignment notification device 51 notifies the offset error estimated by the signal processing unit 4. The mounting angle adjustment device 52 adjusts a mounting angle of the radar device 10 based on the offset error estimated by the signal processing unit 4.

### 1-2. Processing

### 1-2-1. Azimuth Error Calculation Process

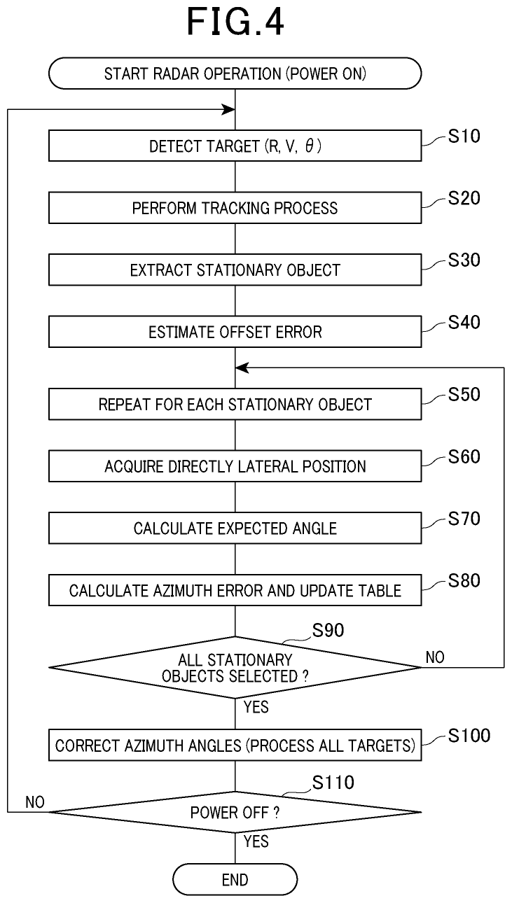

Next, with reference to the flowchart of FIG. 4, an azimuth error calculation process performed by the signal processing unit 4 will now be described. The signal processing unit 4 initiates this process when the vehicle 80 is powered on, for example, when the ignition is turned on.

At step S10, the detection unit 410 detects one or more objects present around the vehicle 80 as targets having target information, based on the reception signal. The target information includes a distance R, a relative speed V, and an azimuth angle θ of each target.

Next, at step S20, the tracking unit 413 performs a tracking process on each of the targets detected at step S10, and acquires a time series of target information corresponding to at least one target. Specifically, the tracking unit 413 selects one target from the at least one target detected in the current processing cycle, that is, in the current processing cycle. The selected target is hereinafter referred to as a first target. The tracking unit 413 determines whether a first object corresponding to the first target is the same as any object corresponding to a target detected at the previous time, that is, in the previous processing cycle. Further, the tracking unit 413 acquires a time series of target information including the target information of the first target and target information corresponding to an object that was detected in the past and determined to be the same as the first object.

The objects determined to be the same as the first object include an object detected in the previous processing cycle, hereinafter referred to as a previous first object. The objects also include an object determined in the previous processing cycle to be the same as the previous first object, hereinafter referred to as the same object in the cycle before the previous processing cycle. The objects further include an object determined in the cycle before the previous processing cycle to be the same as the same object in that cycle, and so on. The tracking unit 413 acquires a time series of target information for each of the targets detected at step S10. The time series of target information includes the target information of the target detected this time and target information corresponding to an object that was detected in the past and determined to be the same as the object corresponding to the current target.

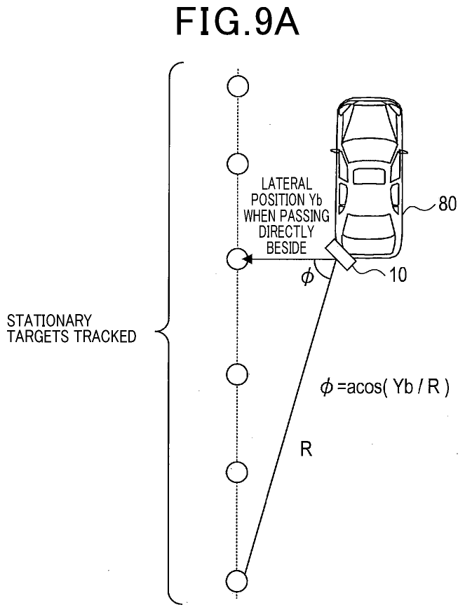

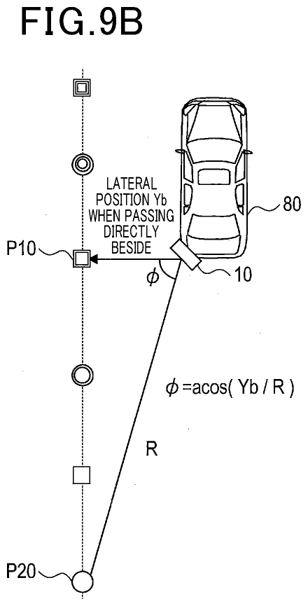

The azimuth error Δθ is calculated as a difference between the detected azimuth angle θ and an expected angle φ expected based on a detected distance R. As illustrated in FIG. 9A, the expected angle φ of the first object is calculated from the distance R to the first object and the lateral position Yb of the first object. The lateral position Yb is a distance from the vehicle 80 to the first object in a direction perpendicular to the travel direction of the vehicle 80, hereinafter referred to as a lateral direction.

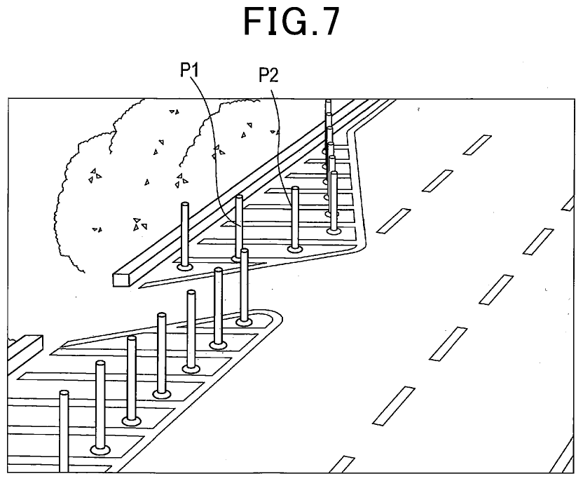

FIG. 9B illustrates a method of calculating the expected angle φ according to a comparative example. As illustrated in FIG. 9B, in the comparative example, it is assumed that a first stationary object P10 and a second stationary object P20, such as roadside objects, are located parallel to the travel direction. The second stationary object P20 is an object different from the first stationary object P10. In the comparative example, when the first stationary object P10 is positioned directly beside the vehicle 80, the lateral position Yb is detected as a distance from the vehicle 80 to the first stationary object P10. Then, the expected angle φ is calculated from the lateral position Yb and the distance R to the second stationary object P20. Accordingly, the azimuth error Δθ with respect to the azimuth angle θ is calculated. The azimuth angle θ is an azimuth angle of the detected second stationary object P20. However, as in the case of the first stationary object P1 and the second stationary object P2 illustrated in FIG. 7, roadside objects present in an actual travel environment are not necessarily located parallel to the travel direction of the vehicle 80. For this reason, in the method according to the comparative example, the expected angle φ may not be calculable.

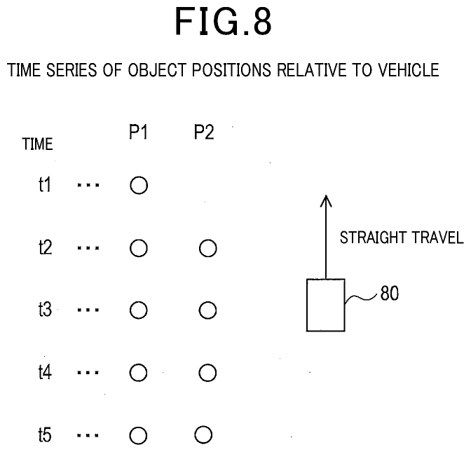

Therefore, in the present embodiment, as described above, the signal processing unit 4 acquires the lateral position Yb of the stationary object based on a time series of target information of the same stationary object, and calculates the expected angle φ. FIG. 8 schematically illustrates a time series of positions of the first stationary object P1 and the second stationary object P2 detected at times t1 to t5. The positions here are positions relative to the vehicle 80, that is, positions with the vehicle 80 as an origin.

When the vehicle 80 travels straight in the lane illustrated in FIG. 7, the first stationary object P1 and the second stationary object P2 appear to move from front to rear relative to the vehicle 80 while being separated from each other by a predefined distance in the lateral direction. Accordingly, for example, when the vehicle 80 passes directly beside the first stationary object P1 at time t3, the expected angle φ corresponding to the azimuth angle θ detected at time t1 can be calculated from the distance R detected at time t3 and the distance R detected at time t1.

When the vehicle 80 is traveling in a manner other than straight travel, for example, along a curve, the signal processing unit 4 corrects, based on the behavior of the vehicle 80, the detected lateral position when the vehicle 80 passes directly beside the stationary object. The signal processing unit 4 estimates the behavior of the vehicle 80, that is, a distance by which the vehicle 80 has moved in the lateral direction, based on detected values output from the on-board sensors 3, for example, a steering angle and/or a yaw rate. Then, using, as a reference, the lateral position of the stationary object when the vehicle 80 passes directly beside the stationary object, the signal processing unit 4 corrects the lateral position of the stationary object based on the estimated behavior of the vehicle 80. Specifically, a value calculated by adding a movement distance to the lateral position at a first time is set as the lateral position at a second time. The first time is the time when the vehicle 80 passes directly beside the stationary object. The movement distance is the distance that the vehicle 80 moves in the lateral direction between the first time and the second time. In this manner, estimating the behavior of the vehicle 80 allows the signal processing unit 4 to calculate the expected angle φ based on the time series of target information of the stationary object. Accordingly, in the present embodiment, the tracking unit 413 acquires a time series of target information of each target.

Next, at step S30, the stationary object determination unit 414 performs a stationary object extraction process. That is, the stationary object determination unit 414 extracts, from at least one target detected in the current processing cycle, a target corresponding to a stationary object. Accordingly, the stationary object determination unit 414 extracts, from at least one time series of target information, a time series of target information corresponding to a stationary object. Details of the stationary object extraction process will be described later.

Next, at step S40, the offset error estimation unit 412 estimates an offset error.

Next, at step S50, one target for which the processes at steps S60 to S90 have not yet been performed is selected from among targets corresponding to all stationary objects extracted at step S30. The processes at steps S60 to S90 are then performed for the selected target, hereinafter referred to as a selected target.

At step S60, the distance acquisition unit 415 performs a directly lateral position acquisition process. Specifically, based on the time series of target information of the selected target, the distance acquisition unit 415 acquires, as the lateral position Yb, the distance R detected when the vehicle 80 passed directly beside the object corresponding to the selected target. Details of the directly lateral position acquisition process will be described later.

Next, at step S70, the expected angle φ=acos(Yb/R) is calculated from the lateral position Yb acquired at step S60 and the distance R detected at step S10.

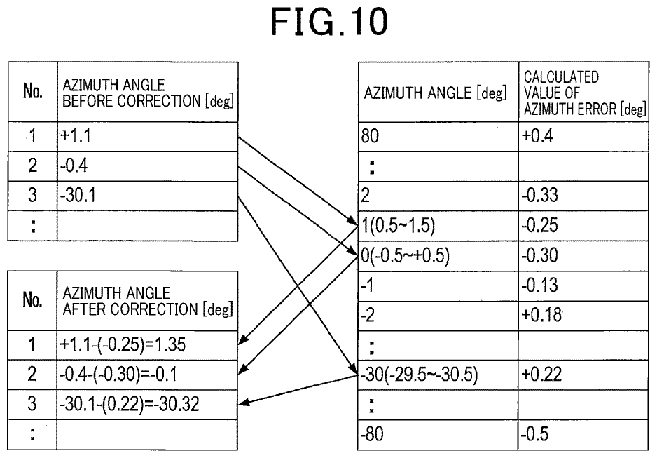

Next, at step S80, the error calculation unit 417 calculates, as the azimuth error Δθ, a difference θ−φ between the azimuth angle θ detected at step S10 and the expected angle φ calculated at step S70. Then, the error calculation unit 417 updates an error table based on the calculated azimuth error Δθ. As illustrated in FIG. 10, in the error table, an azimuth error Δθ is associated with each azimuth angle, and the azimuth error Δθ is stored for each azimuth angle. The error calculation unit 417 updates the azimuth error Δθ associated with the azimuth angle θ in the error table to the azimuth error Δθ calculated at step S80.

Next, at step S90, the error calculation unit 417 determines whether the processes at steps S60 to S80 have been performed for targets corresponding to all stationary objects extracted at step S30. When the error calculation unit 417 determines that the processes at steps S60 to S80 have not been performed for targets corresponding to all stationary objects, the process flow returns to step S50. When the error calculation unit 417 determines that the processes at steps S60 to S80 have been performed for targets corresponding to all stationary objects, the process flow proceeds to step S100.

Next, at step S100, as illustrated in FIG. 10, the error calculation unit 417 corrects the azimuth angles θ of all targets detected at step S10 using the azimuth errors Δθ in the error table.

Next, at step S110, the detection unit 410 determines whether the vehicle 80 has been powered off. When it is determined that the vehicle 80 remains powered on, the process flow returns to step S10. When it is determined that the vehicle 80 has been powered off, the process flow ends.

### 1-2-2. Stationary Object Extraction Process

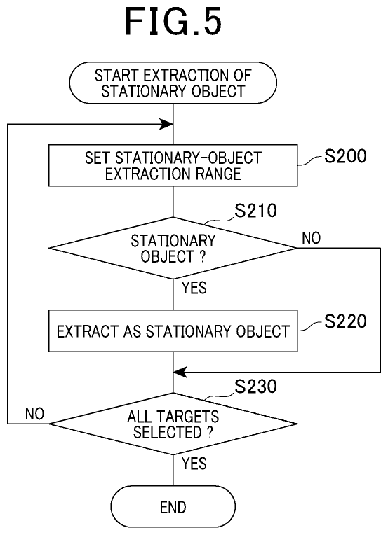

Next, with reference to the flowchart of FIG. 5, the stationary object extraction process performed by the stationary object determination unit 414 will now be described.

At step S200, the stationary object determination unit 414 sets a stationary object extraction range. The stationary object extraction range is a range of relative speeds of stationary objects. The relative speed of a stationary object changes according to the vehicle speed of the vehicle 80. The stationary object determination unit 414 sets the stationary object extraction range, which is a range of relative speeds of stationary objects expected according to the vehicle speed acquired by the speed acquisition unit 411.

Next, at step S210, the stationary object determination unit 414 selects, from among the targets detected at step S10, one target for which the process at step S210 has not been performed, and determines whether an object corresponding to the selected target is a stationary object. When the relative speed of the selected target falls within the stationary object extraction range set at step S200, the stationary object determination unit 414 determines that the object is a stationary object, and proceeds to step S220. When the relative speed of the selected target does not fall within the stationary object extraction range, the stationary object determination unit 414 determines that the object is not a stationary object, skips the process at step S220, and proceeds to step S230.

At step S220, the stationary object determination unit 414 determines that the object corresponding to the target selected at step S210 is a stationary object, and proceeds to step S230.

At step S230, the stationary object determination unit 414 determines whether the process at step S210 has been performed for all of the targets detected at step S10. When the stationary object determination unit 414 determines that the process at step S210 has not been performed for all of the targets, the stationary object determination unit 414 returns to step S200. When the stationary object determination unit 414 determines that the process at step S210 has been performed for all of the targets, the stationary object determination unit 414 terminates this stationary object extraction process, and proceeds to step S40.

### 1-2-3. Directly Lateral Position Acquisition Process

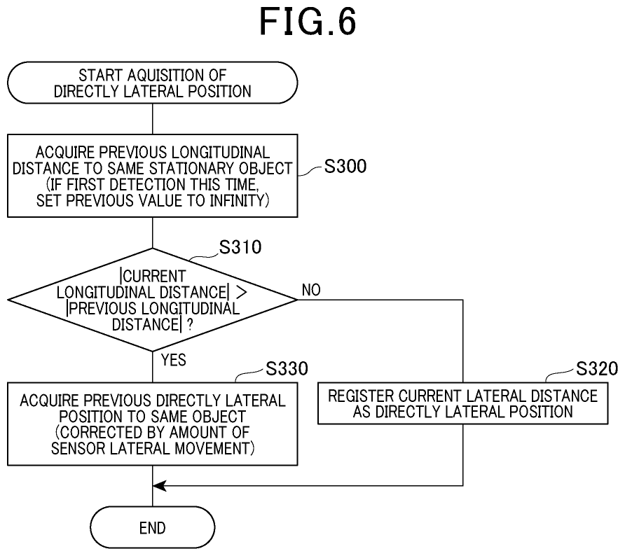

Next, with reference to the flowchart of FIG. 6, the directly lateral position acquisition process performed by the distance acquisition unit 415 will now be described.

At step S300, the distance acquisition unit 415 acquires a longitudinal distance to the same stationary object in the previous processing cycle. The same stationary object is an object that, among objects corresponding to targets detected in the previous processing cycle, is determined to be the same as the stationary object corresponding to the target selected at step S50, hereinafter referred to as a selected stationary object. The longitudinal distance is a distance in the travel direction of the vehicle 80, and is calculated from the detected azimuth angle θ and the distance R. The distance acquisition unit 415 corrects the longitudinal distance based on the offset error estimated by the offset error estimation unit 412. Further, when the vehicle 80 is traveling in a manner other than straight travel, the distance acquisition unit 415 corrects the longitudinal distance based on the behavior of the vehicle 80 such that the longitudinal distance corresponds to a case in which the vehicle 80 is traveling straight. When the selected stationary object is detected for the first time in the current processing cycle, the distance acquisition unit 415 sets the longitudinal distance to the same stationary object in the previous processing cycle to infinity.

Next, at step S310, the distance acquisition unit 415 determines whether an absolute value of the longitudinal distance in the current processing cycle is greater than an absolute value of the longitudinal distance in the previous processing cycle. The longitudinal distance in the current processing cycle is calculated from target information of the selected stationary object. When the distance acquisition unit 415 determines that the absolute value of the longitudinal distance in the current processing cycle is less than or equal to the absolute value of the longitudinal distance in the previous processing cycle, the distance acquisition unit 415 proceeds to step S320. When the distance acquisition unit 415 determines that the absolute value of the longitudinal distance in the current processing cycle is greater than the absolute value of the longitudinal distance in the previous processing cycle, the distance acquisition unit 415 proceeds to step S330.

At step S320, the distance acquisition unit 415 registers, as the directly lateral position Yb, a lateral distance acquired in the current processing cycle. As the vehicle 80 approaches a position directly beside the selected stationary object, the longitudinal distance to the selected stationary object decreases. When the vehicle 80 is positioned directly beside the selected stationary object, the longitudinal distance to the selected stationary object becomes substantially zero, that is, closest to zero. Then, as the vehicle 80 moves away from the selected stationary object, the longitudinal distance to the selected stationary object increases. When the absolute value of the longitudinal distance in the current processing cycle is less than or equal to the absolute value of the longitudinal distance in the previous processing cycle, there is a possibility that the vehicle 80 is passing directly beside the selected stationary object in the current processing cycle. Accordingly, the distance acquisition unit 415 acquires a lateral distance calculated from the azimuth angle θ and the distance R in the current processing cycle, and registers the acquired lateral distance as the directly lateral position Yb of the selected stationary object. After the process at step S320, the distance acquisition unit 415 proceeds to step S70.

At step S330, the distance acquisition unit 415 acquires the directly lateral position Yb in the previous processing cycle of an object determined to be the same as the selected stationary object. When the absolute value of the longitudinal distance in the current processing cycle is greater than the absolute value of the longitudinal distance in the previous processing cycle, the vehicle 80 has already passed directly beside the selected stationary object. Accordingly, the distance acquisition unit 415 acquires the directly lateral position Yb in the previous processing cycle of the object determined to be the same as the selected stationary object. When the vehicle 80 has moved in the lateral direction between the previous and current processing cycles, the lateral position Yb in the previous processing cycle is corrected by a lateral movement amount of the vehicle 80, that is, a lateral movement amount of the radar device 10, and is registered as the lateral position Yb of the selected stationary object. The directly lateral position Yb in the previous processing cycle is the directly lateral position Yb registered at step S330.

Until the vehicle 80 passes directly beside the selected stationary object, the directly lateral position Yb of the selected stationary object is updated in the process at step S320 in each processing cycle. After the vehicle 80 has passed directly beside the selected stationary object, the directly lateral position Yb of the selected stationary object becomes a value based on the value last updated in the process at step S330. That is, the directly lateral position Yb of the selected stationary object becomes a value based on the lateral distance acquired at the time when the longitudinal distance is shortest. After completion of the process at step S330, the distance acquisition unit 415 proceeds to step S70.

### 1-3. Evaluation Results

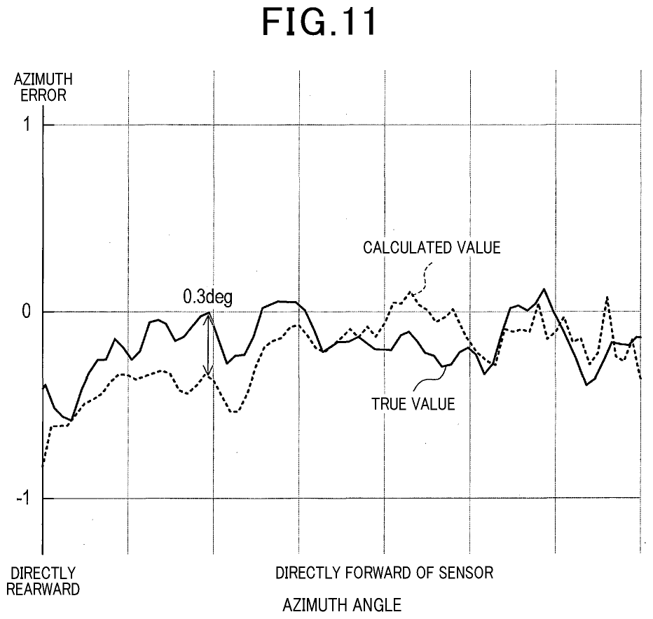

FIG. 11 illustrates a comparison between a calculated value of the azimuth error Δθ for each azimuth angle, calculated by the error calculation unit 417, and a true value of the azimuth error for each azimuth angle, measured in an actual road environment. In FIG. 11, the calculated value of the azimuth error Δθ follows the same trend with respect to the azimuth angle as the true value.

### 1-4. Effects

According to the first embodiment described in detail above, the following effects are achieved.
(1) The signal processing unit 4 acquires a time series of target information for the same stationary object. The detected position of the same stationary object changes over time according to the behavior of the vehicle 80. Accordingly, based on the behavior of the vehicle 80, it is possible to estimate a temporal change in the detected position of the same stationary object and to acquire the directly lateral position Yb while taking the temporal change in position into consideration. Then, the expected angle φ is calculated based on the directly lateral position Yb and the distance R. Accordingly, the signal processing unit 4 can calculate the expected angle φ while suppressing an error caused by an arrangement or shape of the object. Accordingly, the signal processing unit 4 can calculate the azimuth error Δθ with high accuracy.
(2) The distance acquisition unit 415 corrects the target information using the offset error estimated by the offset error estimation unit 412, and acquires the directly lateral position Yb based on the corrected target information. Accordingly, since the adverse effects of axial misalignment of the radar device 10 are suppressed, the accuracy of determining when the vehicle passes directly beside the stationary object can be improved. Accordingly, calculation accuracy of the azimuth error can be improved.
(3) The distance acquisition unit 415 acquires, from the time series of target information for the selected stationary object, a temporal change in the longitudinal distance to the selected stationary object, and can determine, based on the acquired temporal change in the longitudinal distance, the time at which the vehicle 80 passes directly beside the selected stationary object.

### Second Embodiment

2-1. Differences from First Embodiment

Since the second embodiment has a basic configuration similar to that of the first embodiment, differences therefrom will be described below. The same reference numerals as those in the first embodiment denote the same components, and repeated description thereof will be omitted.

In the first embodiment described above, the distance acquisition unit 415 acquires the directly lateral position Yb based on the longitudinal distance to the selected stationary object. In contrast, the second embodiment differs from the first embodiment in that the distance acquisition unit 415 acquires the directly lateral position Yb based on the distance R to the selected stationary object.

### 2-2. Directly Lateral Position Acquisition Process

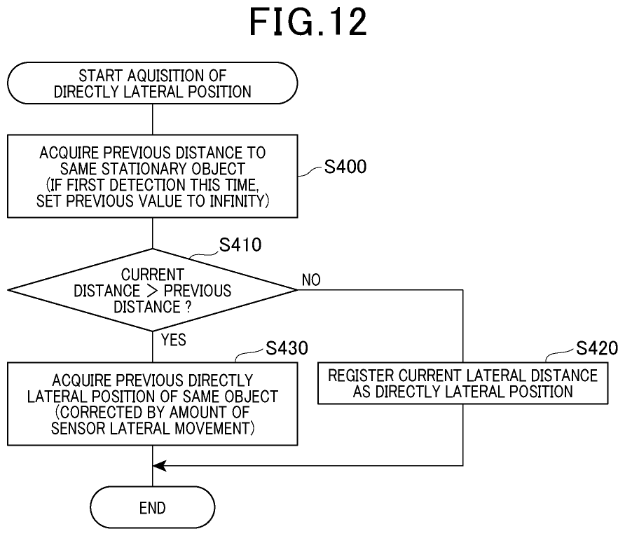

With reference to the flowchart of FIG. 12, a directly lateral position acquisition process performed by the distance acquisition unit 415 of the second embodiment instead of the directly lateral position acquisition process illustrated in FIG. 6 of the first embodiment will now be described.

At step S400, the distance acquisition unit 415 acquires the distance R to the same stationary object in the previous processing cycle. When the selected stationary object is detected for the first time in the current processing cycle, the distance acquisition unit 415 sets the previous distance R to infinity.

At step S410, the distance acquisition unit 415 determines whether the distance R to the selected stationary object detected in the current processing cycle is greater than the distance R to an object detected in the previous processing cycle and determined to be the same as the selected stationary object. When the vehicle 80 is traveling in a manner other than straight travel, the distance acquisition unit 415 corrects the distance R based on the behavior of the vehicle 80 such that the distance R corresponds to a case in which the vehicle 80 is traveling straight. When the distance acquisition unit 415 determines that the distance R in the current processing cycle is less than or equal to the distance R in the previous processing cycle, the distance acquisition unit 415 proceeds to step S420. When the distance acquisition unit 415 determines that the distance R in the current processing cycle is greater than the distance R in the previous processing cycle, the distance acquisition unit 415 proceeds to step S430.

At step S420, the distance acquisition unit 415 performs a process similar to the process at step S320. After completion of the process at step S420, the distance acquisition unit 415 proceeds to step S70. As the vehicle 80 approaches a position directly beside the selected stationary object, the distance R to the selected stationary object decreases, and when the vehicle 80 is positioned directly beside the selected stationary object, the distance R to the selected stationary object reaches a minimum. Then, as the vehicle 80 moves away from the selected stationary object, the distance R to the selected stationary object increases. When the distance R in the current processing cycle is less than or equal to the distance R in the previous processing cycle, the vehicle 80 is likely passing directly beside the selected stationary object in the current processing cycle. Accordingly, the distance acquisition unit 415 registers the lateral distance to the selected stationary object acquired in the current processing cycle as the directly lateral position Yb of the selected stationary object.

At step S430, the distance acquisition unit 415 performs a process similar to the process at step S330. After completion of the process at step S430, the distance acquisition unit 415 proceeds to step S70. When the distance R in the current processing cycle is greater than the distance R in the previous processing cycle, the vehicle 80 has already passed directly beside the selected stationary object. Accordingly, the distance acquisition unit 415 acquires, for an object determined to be the same as the selected stationary object, the directly lateral position Yb in the previous processing cycle.

### 2-3. Effects

According to the second embodiment described in detail above, the effect (1) of the above-described first embodiment is achieved, and the following additional effect is also achieved.
(4) The distance acquisition unit 415 determines, based on a temporal change in the distance R to the selected stationary object, when the vehicle 80 passes directly beside the selected stationary object. This makes it possible to determine when the vehicle 80 passes directly beside the selected stationary object while eliminating the influence of an error in the azimuth angle θ of the selected stationary object.

### Third Embodiment

3-1. Differences from First Embodiment

Since the third embodiment has a basic configuration similar to that of the first embodiment, differences therefrom will be described below. The same reference numerals as those in the first embodiment denote the same components, and repeated description thereof will be omitted.

In the first embodiment described above, the distance acquisition unit 415 acquires the directly lateral position Yb based on the longitudinal distance to the selected stationary object. In contrast, the third embodiment differs from the first embodiment in that the distance acquisition unit 415 acquires the directly lateral position Yb based on the relative speed V of the selected stationary object.

### 3-2. Directly Lateral Position Acquisition Process

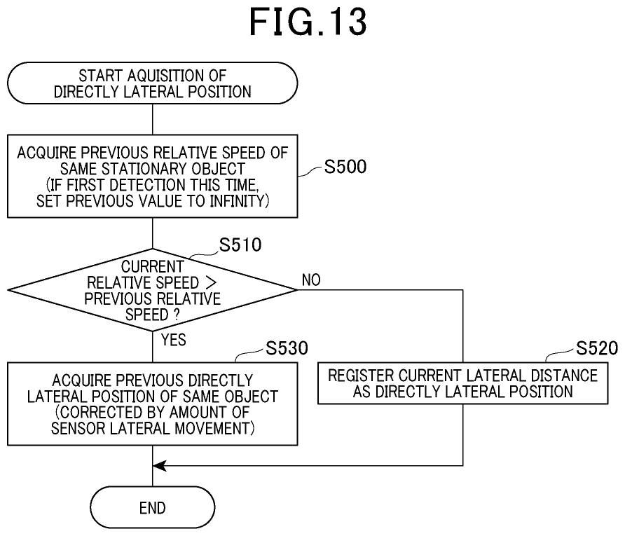

With reference to the flowchart of FIG. 13, a directly lateral position acquisition process performed by the distance acquisition unit 415 of the third embodiment instead of the directly lateral position acquisition process illustrated in FIG. 6 of the first embodiment will now be described.

At step S500, the distance acquisition unit 415 acquires the relative speed V of the same stationary object in the previous processing cycle. When the selected stationary object is detected for the first time in the current processing cycle, the distance acquisition unit 415 sets the previous relative speed V to infinity.

At step S510, the distance acquisition unit 415 determines whether the relative speed V of the selected stationary object detected in the current processing cycle is greater than the relative speed V of an object detected in the previous processing cycle and determined to be the same as the selected stationary object. When the vehicle 80 is traveling in a manner other than straight travel, the distance acquisition unit 415 corrects the relative speed V based on the behavior of the vehicle 80 such that the relative speed V corresponds to a case in which the vehicle 80 is traveling straight. When the distance acquisition unit 415 determines that the relative speed V in the current processing cycle is less than or equal to the relative speed V in the previous processing cycle, the distance acquisition unit 415 proceeds to step S520. When the distance acquisition unit 415 determines that the relative speed V in the current processing cycle is greater than the relative speed V in the previous processing cycle, the distance acquisition unit 415 proceeds to step S530.

At step S520, the distance acquisition unit 415 performs a process similar to the process at step S320. After completion of the process at step S520, the distance acquisition unit 415 proceeds to step S70. As the vehicle 80 approaches a position directly beside the selected stationary object, the relative speed V of the selected stationary object decreases, and when the vehicle 80 is positioned directly beside the selected stationary object, the relative speed V of the selected stationary object becomes substantially zero, that is, closest to zero. Then, as the vehicle 80 moves away from the selected stationary object, the relative speed V of the selected stationary object increases. When the relative speed V in the current processing cycle is less than or equal to the relative speed V in the previous processing cycle, the vehicle 80 is likely passing directly beside the selected stationary object in the current processing cycle. Accordingly, the distance acquisition unit 415 registers the lateral distance to the selected stationary object acquired in the current processing cycle as the directly lateral position Yb of the selected stationary object.

At step S530, the distance acquisition unit 415 performs a process similar to the process at step S330. After completion of the process at step S530, the distance acquisition unit 415 proceeds to step S70. When the relative speed V in the current processing cycle is greater than the relative speed V in the previous processing cycle, the vehicle 80 has already passed directly beside the selected stationary object. Accordingly, the distance acquisition unit 415 acquires, for an object determined to be the same as the selected stationary object, the directly lateral position Yb in the previous processing cycle.

### 3-3. Effects

According to the third embodiment described in detail above, the effects (1) of the above-described first embodiment are achieved, and the following additional effect is also achieved.
(5) The distance acquisition unit 415 determines, based on a temporal change in the relative speed V of the selected stationary object, when the vehicle 80 passes directly beside the selected stationary object. This makes it possible to determine when the vehicle 80 passes directly beside the selected stationary object while eliminating the influence of an error in the azimuth angle θ of the selected stationary object.

### Fourth Embodiment

4-1. Differences from First Embodiment

Since the fourth embodiment has a basic configuration similar to that of the first embodiment, differences therefrom will be described below. The same reference numerals as those in the first embodiment denote the same components, and repeated description thereof will be omitted.

The fourth embodiment differs from the first embodiment in that the signal processing unit 4 calculates the azimuth error Δθ on the condition that the vehicle 80 is traveling straight. That is, in the fourth embodiment, when the vehicle 80 is not traveling straight, the signal processing unit 4 does not update the error table for the azimuth error Δ0.

### 4-2. Azimuth Error Calculation Process

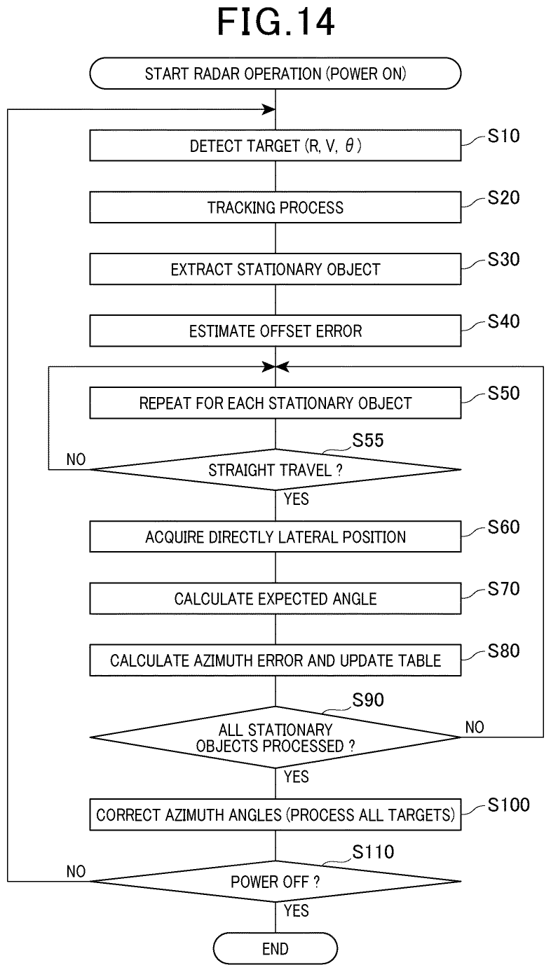

With reference to the flowchart of FIG. 14, a directly lateral position acquisition process performed by the signal processing unit 4 of the fourth embodiment instead of the azimuth error calculation process illustrated in FIG. 4 of the first embodiment will now be described.

In the present embodiment, the signal processing unit 4 performs the process at step S55 in addition to the processes at steps S10 to S100 of the azimuth error calculation process illustrated in FIG. 4. Specifically, between the process at step S50 and the process at step S60, the distance acquisition unit 415 determines whether the vehicle 80 is traveling straight based on a steering angle or a yaw rate of the vehicle 80. When the distance acquisition unit 415 determines that the vehicle 80 is not traveling straight, the distance acquisition unit 415 returns to step S50. When the distance acquisition unit 415 determines that the vehicle 80 is traveling straight, the distance acquisition unit 415 proceeds to step S60.

Accordingly, in the present embodiment, the distance acquisition unit 415 acquires the lateral position Yb of the selected stationary object only when the vehicle 80 is traveling straight. The expected angle calculation unit 416 calculates the expected angle φ only when the vehicle 80 is traveling straight. The error calculation unit 417 calculates the azimuth error Δθ only when the vehicle 80 is traveling straight.

### 4-3. Effects

According to the fourth embodiment described in detail above, the effect (1) of the above-described first embodiment is achieved, and the following additional effect is also achieved.
(6) The error calculation unit 417 calculates the azimuth error Δθ only when the vehicle 80 is traveling straight. During straight travel of the vehicle 80, the lateral distance from the vehicle 80 to the stationary object remains constant. Accordingly, the error calculation unit 417 can calculate the azimuth error Δθ with higher accuracy.

### 5. Other Embodiments

Although embodiments of the present disclosure have been described above, the present disclosure is not limited to any of the above-described embodiments, and various modifications may be made thereto.
(a) The determination at step S310 in the directly lateral position acquisition process of the first embodiment, the determination at step S410 in the directly lateral position acquisition process of the second embodiment, and the determination at step S510 in the directly lateral position acquisition process of the third embodiment may be combined. That is, the distance acquisition unit 415 may perform two or more of the determinations at steps S310, S410, and S510, proceed to steps S220, S320, and S420 when negative determinations are made in all of the two or more determinations, and proceed to steps S230, S330, and S430 when an affirmative determination is made in any of the two or more determinations. By determining, based on a plurality of determination conditions, when the vehicle 80 has passed directly beside the selected stationary object, the accuracy of determining the directly lateral passage timing can be improved. Accordingly, calculation accuracy of the azimuth error can be improved.
(b) In the first embodiment, it is determined that the vehicle 80 passes directly beside the selected stationary object at the time when the absolute value of the longitudinal distance is minimum. However, the vehicle 80 may pass directly beside the selected stationary object between the time when the absolute value of the longitudinal distance is minimum and the subsequent time, that is, the time when the longitudinal distance has increased. Accordingly, the distance acquisition unit 415 may acquire the directly lateral position Yb based on the lateral distance acquired at the time when the absolute value of the longitudinal distance is minimum and the lateral distance acquired at the subsequent time. For example, the distance acquisition unit 415 may acquire, as the directly lateral position Yb, an average of the lateral distances acquired at the above two times. Similarly, in the second embodiment, the distance acquisition unit 415 may acquire the directly lateral position Yb based on the lateral distances acquired at the time when the distance R is minimum and at the subsequent time. In the third embodiment, the distance acquisition unit 415 may acquire the directly lateral position Yb based on the lateral distances acquired at the time when the relative speed V is minimum and at the subsequent time.
(c) The radar device 10 and the method thereof described in the present disclosure may be realized by a dedicated computer provided by configuring a processor and memory programmed to perform one or more functions embodied in a computer program. Alternatively, the radar device 10 and the method thereof described in the present disclosure may be realized by a dedicated computer provided by configuring a processor with one or more dedicated hardware logic circuits. Alternatively, the radar device 10 and the method thereof described in the present disclosure may be realized by one or more dedicated computers configured by a combination of a processor and memory programmed to perform one or more functions, and a processor configured with one or more hardware logic circuits. In addition, the computer program may be stored in a computer-readable, non-transitory tangible storage medium as instructions to be executed by a computer. The functions of the respective units included in the radar device 10 need not be implemented by software, and all of the functions may be implemented by one or more pieces of hardware.
(d) A plurality of functions of one constituent element in the above embodiment may be realized by a plurality of constituent elements, or one function of one constituent element may be realized by a plurality of constituent elements. In addition, a plurality of functions of a plurality of constituent element may be realized by one constituent element, or one function realized by a plurality of constituent elements may be realized by one constituent element. Moreover, a part of the components of the above-described embodiment may be omitted. Furthermore, at least a part of the components of the above-described embodiment may be added to or replaced with the components of another embodiment described above.
(e) In addition to the radar device described above, the present disclosure may also be implemented in various forms, such as a system including the radar device as a constituent element, a program for causing a computer to function as the radar device, a non-transitory tangible storage medium, such as a semiconductor memory, storing the program, and an azimuth error calculation method.

What is claimed is:

1. A radar device for use in a mobile object, comprising:
a detection unit configured to detect, at predefined time intervals, object information on an object present in a detection region around the mobile object based on transmitted and received radar waves, the object information including a distance, a relative speed, and an azimuth angle of the object;
a speed acquisition unit configured to acquire a speed of the mobile object;
a tracking unit configured to
(i) determine whether a first object corresponding to the object information detected by the detection unit at a current time is same as any object corresponding to object information detected by the detection unit at a previous time, and
(ii) acquire a time series of object information, the time series of object information including the object information detected by the detection unit at the current time and object information detected by the detection unit at previous times and corresponding to at least one object determined to be same as the first object;
a stationary object determination unit configured to determine whether the first object is a stationary object based on the relative speed and the azimuth angle included in the object information detected by the detection unit and the speed of the mobile object acquired by the speed acquisition unit;
a distance acquisition unit configured to acquire, when the stationary object determination unit determines that the first object is a stationary object, a first distance corresponding to the distance included in the object information acquired when the mobile object passes directly beside the first object among the time series of object information acquired by the tracking unit;
an expected angle calculation unit configured to calculate an expected angle based on the first distance acquired by the distance acquisition unit and a second distance included in the object information detected by the detection unit at the current time; and
an error calculation unit configured to calculate an azimuth error for each azimuth angle, the error calculation unit being configured to calculate, as the azimuth error at a first azimuth angle included in the object information detected by the detection unit at the current time, a difference between the expected angle calculated by the expected angle calculation unit and the first azimuth angle.

2. The radar device according to claim 1, wherein
the distance acquisition unit is configured to calculate, from the time series of object information, a time series of longitudinal distances in a travel direction of the vehicle, and determine, based on a time when the longitudinal distance is minimum in the calculated time series of longitudinal distances, when the vehicle passed directly beside the first object.

3. The radar device according to claim 1, wherein
the distance acquisition unit is configured to determine, based on a time when the relative speed is closest to zero in a time series of the relative speeds included in the time series of object information, when the vehicle passed directly beside the first object.

4. The radar device according to claim 1, wherein
the distance acquisition unit is configured to determine, based on a time when the distance is minimum in a time series of the distances included in the time series of object information, when the vehicle passed directly beside the first object.

5. The radar device according to claim 2, further comprising:
an offset error estimation unit configured to estimate an offset error of the azimuth angle corresponding to axial misalignment of the radar device, wherein
the distance acquisition unit is configured to (i) correct each of the time series of longitudinal distances based on the offset error estimated by the offset error estimation unit, and (ii) determine, based on a time when the longitudinal distance is minimum in the corrected time series of longitudinal distances, when the vehicle passed directly beside the first object.

6. The radar device according to claim 1, wherein
the distance acquisition unit is configured to determine when the vehicle passed directly beside the first object, based on a time when at least two of three conditions are satisfied:
(i) the longitudinal distance is minimum in a time series of longitudinal distances in the travel direction of the vehicle calculated from the time series of object information;
(ii) the relative speed is closest to zero in a time series of the relative speeds included in the time series of object information; and
(iii) the distance is minimum in a time series of the distances included in the time series of object information.

7. The radar device according to claim 1, wherein
the error calculation unit is configured to calculate the azimuth error when the mobile object is traveling straight.
